(19) United States
(12) Patent Application Publication
(10) Pub. No.: US 2006/0288168 A1
(43) Pub. Date: Dec. 21, 2006

(54) Transportable computing environment

(76) Inventor: Will Stevenson, Englewood, CO (US)

Correspondence Address: HENSLEY KIM & EDGINGTON, LLC, 1660 LINCOLN STREET, SUITE 3050, DENVER, CO, 80264, US

(21) Appl. No.: 11/400,014

(22) Filed: Apr. 6, 2006

Related U.S. Application Data
(63) Continuation-in-part of application No. 11/366,206, filed on Mar. 1, 2006.
(60) Provisional application No. 60/669,037, filed on Apr. 6, 2005.
(60) Provisional application No. 60/657,838, filed on Mar. 1, 2005.

(51) Int. Cl. G06F 12/00

(52) U.S. Cl. 711/115

(57) ABSTRACT

A user's computing environment is imaged and copied to a transportable storage medium and virtualization technologies are utilized to allow the booting of the transportable storage medium on a host computer system. A virtual computing environment manager may exploit virtual machines, micro-kernels, boot loaders, and embedded driver sets to allow the transportable storage medium to be bootable and executable regardless of the hardware platform to which the transportable storage medium is attached. The user's computing environment is instantiated on a virtual machine implemented on the host computer system rather than using, altering, or otherwise effecting the applications, settings, or data on the host computer system. Thus, users can easily transport their entire computing environment among various hardware platforms on any host computer system.

### CROSS-REFERENCE TO RELATED APPLICATIONS

This application claims the benefit of priority pursuant to 35 U.S.C. § 119(e) of U.S. provisional application No. 60/669,037 filed 6 Apr. 2005 entitled “Transportable Virtual-Machine-Abstracted Computing Environment,” which is hereby incorporated herein by reference in its entirety. The present application is a continuation-in-part of U.S. patent application Ser. No. 11/366,206 filed 1 Mar. 2006 entitled “Computing Environment Assurance Tool,” which is hereby incorporated herein by reference in its entirety. The present application is also related to U.S. provisional application No. 60/57,838 filed 1 Mar. 2005 entitled “General Purpose Operating Environment Assurance Tool,” which is hereby incorporated herein by reference in its entirety.

### TECHNICAL FIELD

The invention relates generally to computer software and systems and the ability to provide transportable computing accessibility to a user.

### BACKGROUND

Currently, users are locked into individual computers because their programs, settings, and information (collectively, “computing environment”) are stored in those computers and it is difficult to move the complete computing environment from computer to computer. For example, laptop computers are extremely popular because professionals and students need to transport their computing environments between work or class and home. Today, portable computers are the primary option to address this need. However, portable computers can be low-powered, bulky and difficult to transport. Further, the solution is imperfect, as switching between laptops and desktops raises data synching and updating issues as well as incompatibilities and operational differences between the diverse operating systems and applications residing on the different hardware platforms.

Other users address this need portability through the use of portable data devices such as removable hard drives; memory keys, sticks, or cards; rewritable compact disks (CD); or high capacity magnetic media (e.g., zip drives). These solutions, although usually less bulky and more easily transportable than laptop computers, often have problems with configuration and synchronization. Furthermore, conventional removable drive technologies add complexity to the computing environment because of the additional drive letter and storage location choices they present to the user. Other solutions, for example, Web hosted environments, have other disadvantages, including, for example, a need to be connected to the Web host and a lack of full operating system recovery.

Furthermore, if a computer fails, the user's computing environment may be lost or corrupted. A computer user may use two or more computers, but each of the individual computers typically contains programs, settings, and/or information that are different from those on the other computer(s). Consequently, failure of just one of the computers means the loss of at least a portion of the user's software and data. Even if the user has performed a backup operation, the recovery process can be cumbersome and typically fails to provide up-to-the-minute backup and restoration of the user's software and data. Accordingly, backups are often completed sporadically, if at all.

The information included in this Background section of the specification, including any references cited herein and any description or discussion thereof, is included for technical reference purposes only and is not to be regarded subject matter by which the scope of the invention is to be bound.

### SUMMARY

A user's computing environment is imaged and copied to a transportable storage medium and virtualization technologies are utilized to allow the booting of the transportable storage medium on a host computer system. A virtual computing environment manager may exploit virtual machines, micro-kernels, boot loaders, and embedded driver sets to allow the transportable storage medium to be bootable and executable regardless of the hardware platform to which the transportable storage medium is attached. The user's computing environment is instantiated on a virtual machine implemented on the host computer system rather than using, altering, or otherwise effecting the applications, settings, or data on the host computer system. Thus, users can easily transport their entire computing environment among various hardware platforms on any host computer system.

The benefits of virtualization are further supplemented by functionally separating data into three basic computing categories: executable data, settings data, and user data. Executable data includes instructions that execute in memory; settings data configure how the executable data runs; and user data represents input, output and intermediate information with which the executable data operates. Functionally separating these three categories of data allows definition of a computing assurance model by which all major necessary computing components required to participate in a computing environment are made transparent, recoverable, and available. The system makes these computing components available to a user by storing them on a transportable storage medium via imaging and copying.

A user's complete computing environment is thus stored on a transportable storage medium. The transportable storage medium can be removable, detachable, remote, or otherwise portable or separable from the primary computer and any other host computer. User data is located on the transportable storage medium, and the host computer's operating system is bypassed in favor of an operating system running within a virtual machine on top of the host computer's operating system such that access requests for user data are automatically routed to the transportable storage medium. The virtual computing environment manager facilitates the configuration of the virtual machine on the host computer and the implementation of the transportable computing environment.

Executable and settings data may be imaged to the transportable storage medium which may also provide convenient backup and restoration of the executable and settings data for a primary or host computer system. Such imaging can be repeated at various intervals to provide updated backups. In so doing, a totality of a user's computing environment can be recovered and/or operated from the transportable storage device, including operating system, applications, settings and stored data;

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave or other communication media by a computing system and encoding the computer program. Other features, details, utilities, and advantages of the present invention will be apparent from the following more particular written description of various embodiments of the invention as further illustrated in the accompanying drawings and defined in the appended claims.

### BRIEF DESCRIPTIONS OF THE DRAWINGS

FIG. 1 illustrates an exemplary computing and operating environment framework.

FIG. 2 illustrates a layered conceptualization of an exemplary transportable computing platform framework.

FIG. 3 illustrates a plurality of exemplary host computer systems.

FIG. 4 illustrates exemplary operations for applying a virtual operating environment manager to a computing system.

FIG. 5 illustrates exemplary operations for performing a remount volume operation.

FIG. 6 illustrates exemplary operations for performing a data identification operation.

FIG. 7 illustrates exemplary operations for performing a data pointer modification operation.

FIG. 8 illustrates exemplary operations for performing a data loading operation.

FIG. 9 illustrates exemplary operations for performing a boot operation from a transportable storage device to establish a virtual computing environment on a host computer system.

FIG. 10 illustrates exemplary operations for automatically establishing a virtual computing environment on a host computer system.

FIG. 11 illustrates an exemplary computer system useful in implementations of the described technology.

### DETAILED DESCRIPTION

The use of a transportable storage medium allows elements that are important to a typical user's computing environment to be separated from a hardware platform. As such, the user's computing environment may be stored on the transportable storage medium, while what remains on the local hardware platform is disposable or replaceable from data stored on the transportable storage medium. Once a user's environment data is imaged and copied to the transportable storage medium, the user's computing environment becomes transportable among hardware platforms.

Such transportability may be achieved through the use of a virtual computing environment manager stored on transportable storage medium that harnesses virtual machine code running on a base operating system on a host computer system. The virtual machine code and base operating system may be resident and instantiated on the host computing system. Alternatively, a micro operating system and virtual machine code may reside on the transportable storage medium with the virtual computing environment manager and may be instantiated on the host computer system by the virtual computing environment manager. The virtual computing environment manager may comprise a boot process (typically via system BIOS) and a micro operating system to facilitate loading of the virtual machine code used to boot the image of the user's operating system stored on the transportable storage medium.

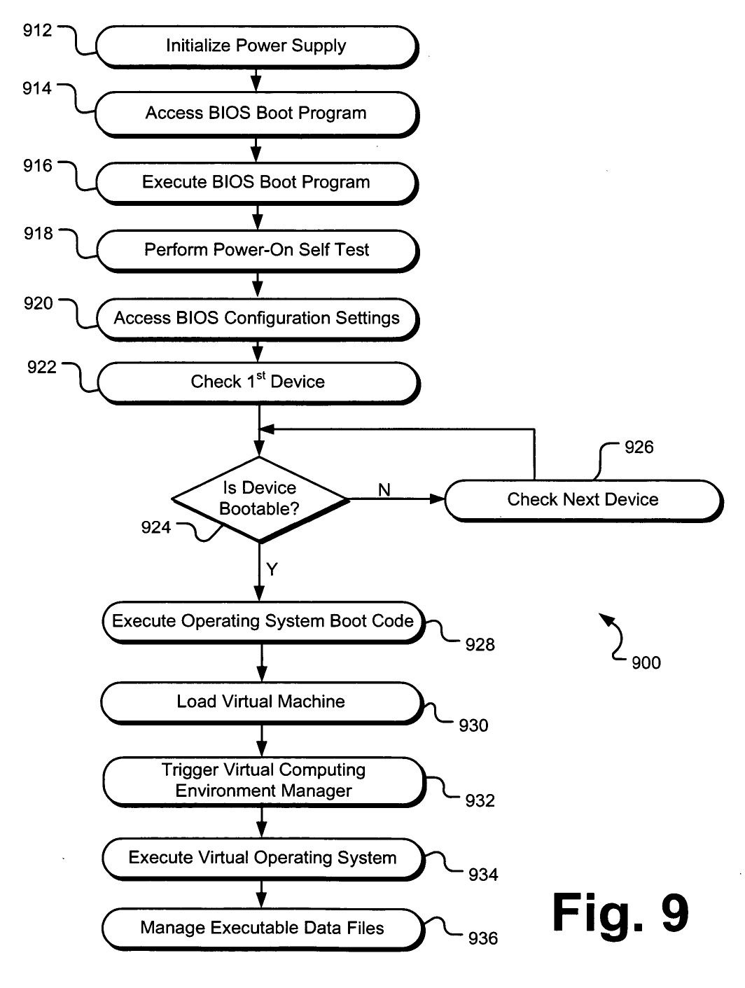

The virtual computing environment manager provides the mechanism for a virtual machine interface to exist at the lowest possible layer of operations. When the hardware of a host computer system boots using a basic input output system (BIOS), the BIOS in turn loads an operating system on the host computer system or a micro-operating system loaded from the transportable storage medium (as described later herein with respect to FIG. 9). A virtual machine layer managed by the virtual computing environment manager is then loaded and configured as well. The virtual computing environment manager then loads the user's operating system stored on the transportable storage medium for execution with the virtual machine layer to instantiate the user's virtual computing environment.

The virtual computing environment manager manages hardware simulation decisions within the virtual machine, for example, central processing unit (CPU) allocation, memory allocation, network interface determination, and storage allocation for translation and emulation operation. The virtual computing environment manager is also responsible for managing the meta-control of a virtual machine including the ability to save state information, restore state information, and suspend or resume operations. The virtual computing environment manager leverages the virtual machine technology to provide reliability, manageability, and increased functionality without adding further complexity to the operating environment.

The virtual computing environment manager queries the hardware on a host computer system for available resources. These resources may include, but are not limited to the CPU, memory, disk space or other storage, busses (e.g., USB, serial, parallel, etc.), and video. The virtual computing environment manager queries these resources to provide those resources appropriately to the virtual machine. Since the virtual machine is the primary place of operations for the virtual computing environment of the user, the virtual machine should be allocated a significant majority of those resources and should act and operate with priority. In another implementation, the host computer system may support multiple users and/or other processes and resources of the host computer system may be allocated and prioritized as appropriate.

The role of the virtual computing environment manager is then to assign these resources with majority and priority as necessary to minimize the impact and maximize the transparency of the operation of the virtual machine to the end user. Such operations may include the direct and sole assignment of busses to the virtual machine. For example, the micro operating system should not have priority to devices attached via the host computer system bus (e.g., USB devices). In a particular example, if the micro operating system were assigned to the printer rather than the transportable computing environment, such an assignment would change the expected behavior for the end user and serve little beyond supporting administrative services. The transportable computing environment may have priority and locked access to those bus-attached devices such that the behavior of a device when attached is no different from that of a non-virtual machine hosted environment.

Similar in dependency although different in delivery is the assignment of CPU resources. One possible application of the virtual computing environment manager is the assignment of CPU and memory resources. Although a significant majority of such resources should be allocated to the transportable computing environment, some small portion should be reserved for the micro operating system that is used to bootstrap the virtual machine code and virtual computing environment manager onto the host system.

The virtual computing environment manager may also have the capacity through extended features to enhance the protection from and recovery after a disaster such as a disk crash. Such features may include, for example, safer suspending of the transportable computing environment, complete backup and restore in a simple, one-step manner; saving state information before loading dangerous software; or saving state information before others use the host computer. The virtual computing environment manager provides an ability to save “states” of the computing environment because the virtual computing environment manager is architecturally “under” the transportable computing environment. Abilities to create transparent, real-time and complete backups are possible without the need to suspend current operations or be concerned that open/locked files or dependencies will interfere or that such a backup might not include pieces that are typically missed by file-based backups.

The virtual computing environment manager manages these resources by making calculated decisions to simplify the utility and transportability of the transportable computing environment hosted by the virtual machine. The user thus benefits from the strengths of the transportable computing environment running on a virtual machine, because the virtual machine behaves as if no additional complexity existed and there is no additional need to manage it.

The boot mechanism also enables access to the transportable storage medium as if it were a normal drive, partition, or any other form of implied drive access methodology. Access can be provided via BIOS, a boot manager, or any other boot control device.

Compression of the bootable transportable storage medium image may also be performed. Compression is beneficial for a number of reasons including, for example, to decrease the space required for storage of the image and as a security mechanism (via any number of compression algorithms). Similarly, encryption may be used on the transportable storage device in order to enable authentication and authorization, for example, by keying the transportable storage medium to the user by common technologies like PKI. In one implementation, a PKI container may be created and an existing user key may be leveraged, or a new one created, assuring that the content on the transportable storage medium belongs to the user. A layer of abstraction can also be utilized, thereby creating the opportunity to employ a mechanism by which “authentication” can occur. In other implementations, a simple password could be required, although other features such as biometric identification could also be utilized.

One of the intrinsic benefits of a virtualized computing environment is the abstraction of hardware from software. Virtualization creates a uniform platform that appears to be the same hardware on a different computing system platform. This enables the virtual machine code to be implemented on disparate hardware platforms without reconfiguration or hardware detection as the hardware is effectively shielded from the software by the virtual machine.

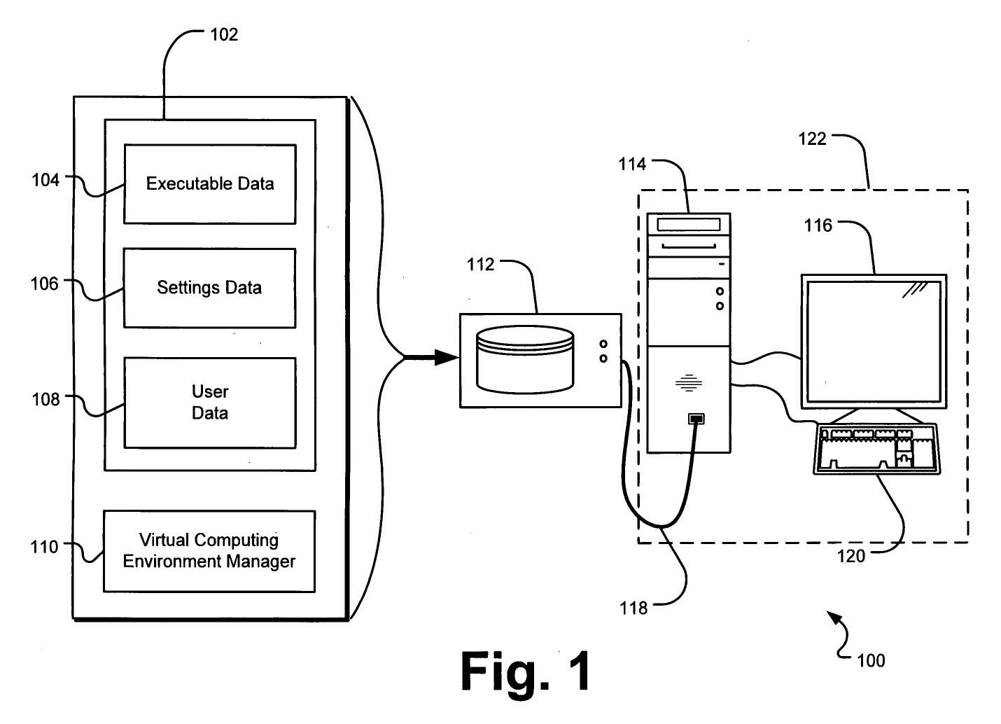

FIG. 1 illustrates an exemplary transportable computing platform framework 100, including a transportable storage device 112 containing a transportable storage medium, which may be coupled to a computer system, such as the host computer system 122. The host computer system 122 may comprise a personal computer 114 (PC) having a display device 116 and a keyboard 120. The transportable storage medium 112 may comprise any type of storage device, including, for example, a hard drive, a memory stick, key, or card, a PCMCIA drive, a PC Card, a PC Express Card, a removable magnetic media (e.g., a zip disk) a rewritable CD or DVD, or a network drive. The transportable storage device 112 may be coupled to the host system 122 in a variety of ways including, for example, by a universal serial bus (USB) cable 118 or via any currently available or future technologies, such as via a direct interface (e.g., a USB port), a wired link (e.g., Firewire, USB cable, Ethernet), or via a wireless link (e.g., Bluetooth or Wi-Fi).

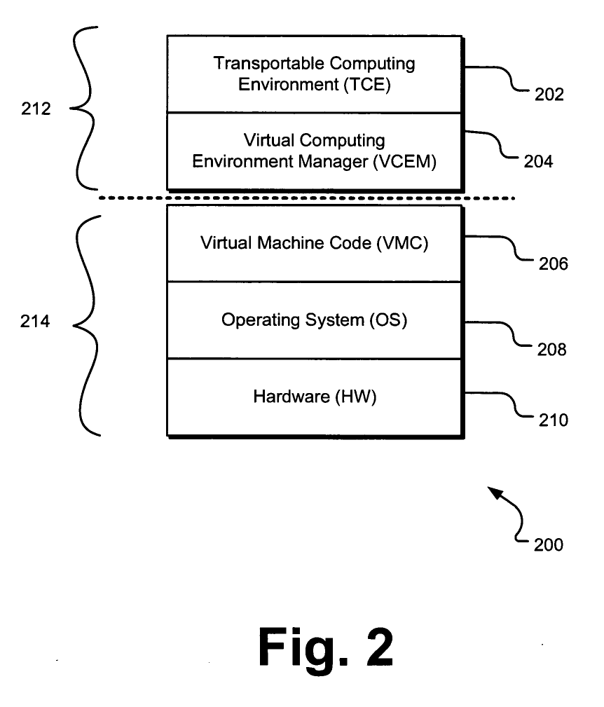

With continuing reference to FIG. 1, the transportable storage device 112 stores a transportable computing environment 102 and a virtual computing environment manager 110 on the transportable storage medium. The virtual computing environment manager 110 operates to interface between the transportable computing environment 102 and a virtual machine (described below in further detail with respect to FIG. 2) to create a virtual computing environment on the host computer system 122.

In a conventional computing environment, executable data, settings data, and user data are relatively unstructured and jumbled together on a primary storage medium, e.g., the hard drive of a user's personal computer.

In one implementation of the transportable computing platform framework 100, however, the virtual computing environment manager also operates to structure and functionally separate this conventionally unstructured data on a user's computer and transfer the unstructured data onto the transportable storage device 112 to create the transportable computing environment 102. In an exemplary implementation, such conventionally unstructured data may be functionally separated into executable data 104, settings data 106, and user data 108. These three types of data, i.e., executable data 104, settings data 106, and user data 108, generally comprise the elements that are important to the typical user's computing environment. More, less, or other data types or schemes may also be implemented.

Executable data 104 may include instructions that execute in memory such as software applications (e.g., the Microsoft Outlook email program) and operating system code (e.g., the Apple OS-X operating system). Settings data 106 may configure how the executable data 104 runs. A common example of settings data 106 in the Windows operating system is data from the Windows registry. User data 108 may comprise input, output, and intermediate data on which the executable data 104 operates. Examples of user data 108 include a text file containing a favorite recipe, a jpeg file containing a family photograph, and a video file containing a recording of a child's soccer game.

In order to initially create the transportable computing environment 102 on the transportable storage device 112, the executable data 104 and settings data 106 from the user's personal computer (or other device) can be captured in a disk image (or any other suitable copying technique) of a storage medium (e.g., a local hard drive) on the user's personal computer or some form of secondary storage media (e.g., a removable hard drive). The user data 108 may also be copied from the user's personal computer, but a disk image of the user data 108 may not be necessary. In the case of a Virtualized Computing environment, the user data could be implemented in a ‘virtual network share’ of a common file system directory enabling a VM to access the data in a secure fashion, but also allow that data to be accessed by plugging the device into a regular system and require no special software to access. Note that if a user has not previously used or configured a personal computer, the transfer of unstructured data may be unnecessary. In such a case, the transportable storage medium may be preloaded with executable data 104 (e.g., an operating system and applications), and default settings data 106. However, the transportable storage medium would not have any user data 108 until such data was created by the user upon instantiation and use of a virtual computing environment on a host computer system 122 using the virtual computing environment manager 110.

Imaging the executable data 104 and settings data 106 may also enable convenient backup and restoration of the data from the transportable storage device 112. Imaging can be repeated at various intervals to provide updated backups. In addition, the user data 108 can be relocated to the transportable storage medium as well. This relocation to the transportable storage medium functionally separates and makes recoverable all of the elements that are important to the typical user's computing environment 102. As such, the user's entire environment may be stored on the transportable storage device 112, while what remains on the user's local computing system is disposable or replaceable from data stored on the storage medium.

As shown in FIG. 2, it may be helpful to conceptualize an exemplary transportable computing platform framework 200 in layers. An exemplary transportable computing platform framework 200 may generally comprise a storage medium 212, coupled to a host system 214, as described above with reference to FIG. 1. The transportable storage medium 212 may comprise the transportable computing environment 202 and the virtual computing environment manager 204. The transportable computing environment 202 comprises the executable data 104, settings data 106, and user data 108 shown in FIG. 1. The host computer system 214 may comprise a hardware 210 layer (e.g., the CPU), an operating system 208 layer, and a virtual machine 206 layer. In an alternate implementation, software code for the operating system 208 layer and/or the virtual machine 206 layer may originate from the transportable storage medium 212 rather than the host computer system 214.

In order to instantiate the transportable computing environment 202 on a host computing system, the virtual computing environment manager 204 may be read from the transportable storage medium 212 and loaded onto the host computer system 214. The virtual computing environment manager 204 then configures the virtual machine 206 layer to emulate a hardware configuration operable by the transportable computing environment 202. The virtual computing environment manager 204 triggers execution of the transportable computing environment 202, which runs on the virtual machine 206. The virtual machine 206 in turn controls the operating system 208 and/or the hardware 210 on the host computing system 214 to implement the operations requested by the transportable computing environment 202. The virtual computing environment manager 204 may be conceptualized as type of linking pathway or “conduit” between the transportable computing environment 202 and the virtual machine layer 206.

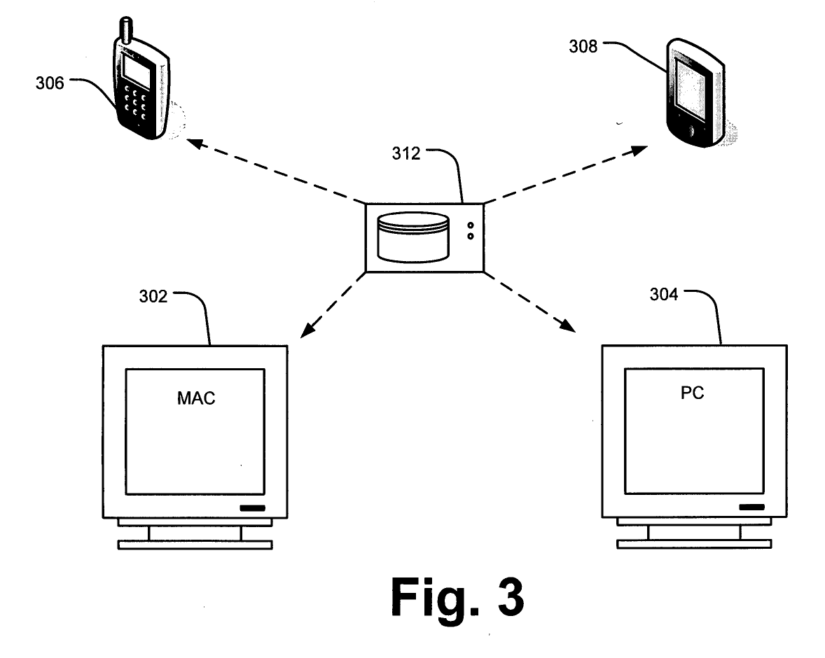

The host computer system may comprise a number of different types of systems and devices as shown in FIG. 3. Exemplary host computer systems may include, but are not limited to, a Macintosh computer 302, a PC 304, a laptop computer, a wireless smart telephone 306, a personal digital assistant 308 (PDA), a portable music player, and any number of hand-held, portable processing devices, as generally shown in FIG. 3. The transportable storage medium 312 may be transportable among different host systems for a user's convenience.

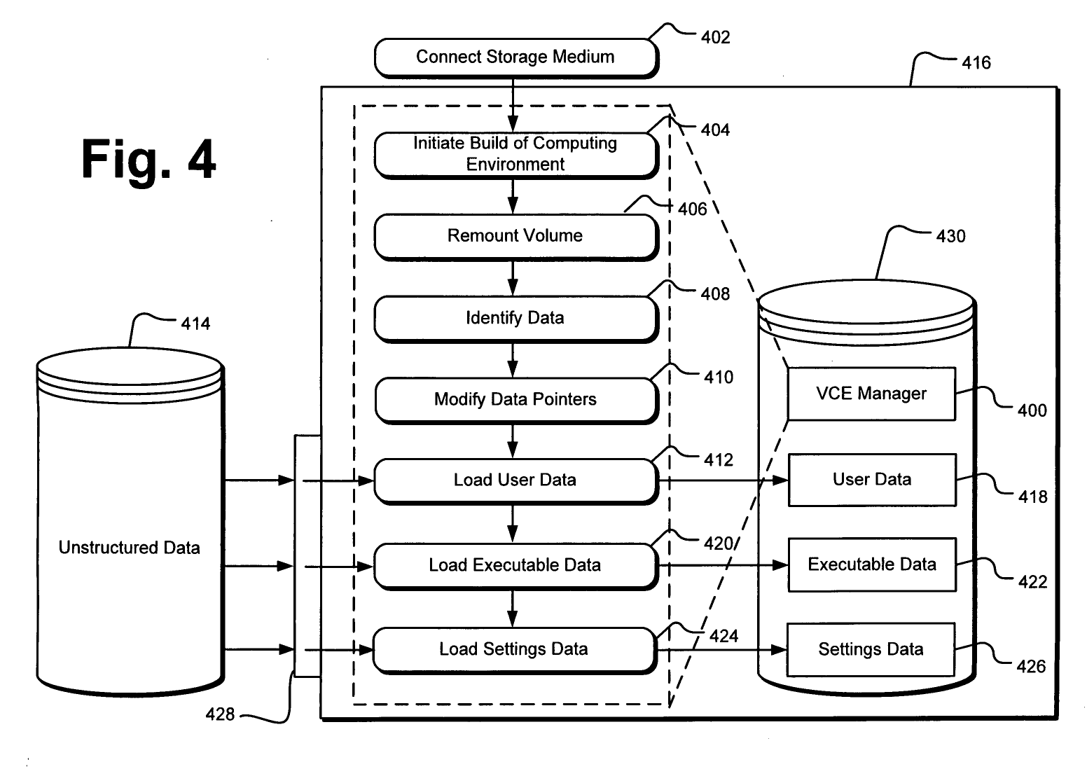

FIG. 4 illustrates an exemplary implementation of the creation of a transportable computing environment. The transportable computing environment is stored on a transportable storage device 416 that has a communications interface 428 and a computer-readable storage medium 430. The communications interface, for example, a USB or Firewire link, is adapted to communicate with a host computing system. The storage medium, for example, a flash memory drive, stores computer-executable instructions for performing a computer process for implementing several modules. A management reading module reads a virtual computing environment manager from the transportable storage device. A management execution module executes the virtual computing environment manager on the host computing system. An environment reading module reads, through the virtual computing environment manager, the transportable computing environment from the transportable storage device. An environment execution module further triggers execution, through the virtual computing environment manager, of the transportable computing environment within a virtual machine on the host computing system.

A virtual computing environment manager 400 provides a transportable computing environment comprising structured user data 418, executable data 422, and settings data 426 on a transportable storage medium 416 from a user's initial computing environment containing relatively unstructured data 414. Alternate implementations could involve transferring data from one or more unstructured data repositories onto one or more transportable storage media. In FIG. 4, the connecting operation 402 connects the transportable storage medium 416 to a user's initial computing system. The transportable storage medium 416 may comprise any type of storage medium including, but not limited to, a hard drive, memory stick or card, PCMCIA drive, PC Card, PC Express Card, rewritable CD or DVD, or a network drive. Furthermore, the method of attaching the transportable storage medium 416 to the user's initial computing system may include, but is not limited to, connecting, plugging, inserting, wirelessly linking, or otherwise interfacing the transportable storage medium 416 and the computing system.

The initiating operation 404 initiates a build of a computing environment on the transportable storage medium 416. It should be noted that FIG. 4 illustrates an exemplary application of a virtual computing environment manager 200 to a user's initial computing environment and initiating the build of a transportable computing environment 404 that may be only a single operation in a larger overall process.

The remount volume operation 406 examines the connection or “mount point” between the transportable storage medium 416 and the computing system. If the computer system has mounted the transportable storage medium 416, the remount volume operation 406 removes the mount point. If the computer system has not mounted the transportable storage medium 416, the remount volume operation 406 does not attempt to remove a non-existent mount point. Examples of mount points include drive letters, volume names, etc. The remount volume operation 406 creates a mount point for the transportable storage medium 416 that represents the location of the transportable storage medium 416 within the computing system.

The identify data operation 408 examines the relatively unstructured data 414 to identify the unstructured data 410 as user data 418, executable data 422, or settings data 426. There are many possible methods of examining the unstructured data 414. In one implementation, the identify user data operation 408 searches the unstructured data 414 for identifying characteristics in order to distinguish and locate the different types of data. In another implementation, the identify user data operation 408 accesses metadata and uses the information contained therein to identify the data types. In the implementation illustrated in FIG. 4, only a single, relatively unstructured data repository 414 is displayed. In an alternate implementation, the computing environment can be spread out over multiple relatively unstructured data repositories.

In yet another implementation of the identify data operation 408, data locations are captured by examining the data pointers in the computer system. This implementation may take the form of a registry, ini-file, and/or disk walker tool that finds the location of pointers within the operating system where the operating system would like the user to work with particular content. When an operating system, a program, or some process requests particular data, the data pointers tell the requester where to look on the computer system storage media to find the particular data. For example, a Windows XP operating system uses one or more data pointers that reference the volume containing the “My Documents” folder on a primary hard drive. When a user accesses the My Documents folder, the pointers direct the request to the appropriate location on the primary hard drive in order to access the My Documents folder data.

In the implementation illustrated in FIG. 4, the modify data pointers operation 410 reads existing data pointers for user data and modifies them to point to locations on the transportable storage medium 416 to which the user data will be relocated. In this manner, the modify data pointers operation 410 architecturally segregates this user data element from the executables and settings data.

The load user data operation 412 relocates (e.g., by a copy or a move operation) the identified unstructured user data identified in the identify data operation 408 from the original storage medium on the user's computer system to the transportable storage medium 416 as structured user data 418. Thus, in the above My Documents folder example, once the relocation of user data (which includes the My Documents folder) has occurred, an attempt by the user to access the My Documents folder is directed by the data pointers to the appropriate location on the transportable storage medium 416. The user then “works” with the user data on the transportable storage medium 416.

The load executable data operation 420 reads the executable data that was identified in the identify data operation 408 and images it onto the transportable storage medium 416 as structured executable data 422. In an alternate implementation, the load executable data operation 420 utilizes any of a number of procedures that, though technologically similar to imaging, are distinct methods of relocating data (e.g., copy, backup, compress and copy, etc.).

The load settings data operation 424 reads the settings data that was identified in the identify data operation 408 and images it onto the transportable storage medium 416 as structured settings data 426. In an alternate implementation, the load settings data operation 424 utilizes any of a number of procedures that, though technologically similar to imaging, are distinct methods of relocating data (e.g., copy, backup, compress and copy, etc.). Each of the three data types can be relocated to a single storage medium or to multiple storage media. In the implementation illustrated in FIG. 4, the executable data and settings data are loaded separately. In an alternate implementation, the executable data and settings data are loaded concurrently.

Once the data has been relocated onto a transportable storage medium 416, the storage medium 416 can be removed or otherwise disconnected from the original computing system and transported and connected to a different host computing system. For example, a CEO of a multi-office company orders three computers, and places one in each her three offices. The CEO works for two months in the first office and then uses the virtual computing environment manager to relocate her user data, executable data and settings data to a transportable storage device. The next month, the CEO travels to her second office. She connects the transportable storage device to the second computer. The tool virtual computing environment manager creates a virtual computing environment on the second computer and allows access to her user data on the transportable storage device. In effect, the second computer has the same computing environment as her first computer. The process is repeated the next month when the CEO travels to her third office. Once again, simply by transporting her transportable storage medium she is able to replicate her original computing environment on the new computer.

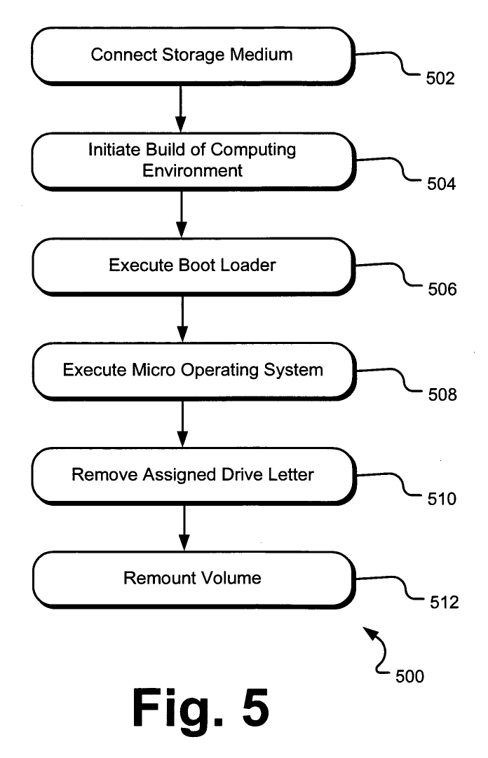

FIG. 5 illustrates an exemplary implementation of the remount volume operation 406 discussed with reference to FIG. 4 above. The illustrated remount volume implementation 500 is initiated by the connect storage medium operation 502. In an alternate implementation, a user may initiate the process manually, for example, by launching a program containing code for the virtual computing environment manager or by clicking on a Web link that downloads code for the virtual computing environment manager. In FIG. 5, the connecting operation 502 connects the transportable storage medium to a computing system. As discussed above, the transportable storage medium could be any type of storage medium including, but not limited to, a hard drive, memory stick or card, PCMCIA drive, PC Card, PC Express Card, rewritable CD or DVD, or network drive. Furthermore, the method of attaching the transportable storage medium to the computing system includes, but is not limited to, connecting, plugging, inserting, wirelessly linking, and otherwise interfacing the transportable storage medium and the computing system.

The initiating operation 504 initiates the build of a transportable computing environment on the transportable storage medium. The execute boot loader operation 506 launches a boot loader. The boot loader bypasses the operating system boot process generally found in files on the hard drive of the host computer system. In one implementation, the boot loader presents a user with a selection of boot options including executing a micro operating system. In another implementation, the boot loader launches the micro operating system directly. The execute micro operating system operation 508 eschews the operating system installed on the host computer system hard drive and instead launches a micro operating system provided on the transportable storage media.

The execute micro operating system operation 508 examines the connection or “mount point” between the transportable storage medium and the host computer system. Most operating systems automatically recognize and mount external devices, in this case the transportable storage medium, when they are attached or otherwise connected to the host computer system.

The remove assigned driver letter operation 510 examines the mount point and determines its type. Examples of mount point types include drive letters (e.g., “d:\”) and volume names (e.g., “\NewDrive\”). If the computer operating system automatically assigned a drive letter to the transportable storage medium, the remove assigned drive letter operation 510 removes the assigned drive letter. In another implementation, if the computer operating system assigned a volume name to the transportable storage medium, the remove assigned drive letter operation 510 removes the volume name.

The remount volume operation 512 creates a mount point for the transportable storage medium that represents the location of the transportable storage medium within the computing system, but renders the mount point transparent to the user. In one implementation, the remount volume operation 512 may hide or obfuscate in some manner the new mount point that it creates in order to simplify the appearance of the computer system from a user perspective. In particular, once the virtual computing environment is instantiated, the user will not “see” the transportable storage device as a separate device connected to the host computer system, but all of the user data files may be available to the user as if stored in the normal locations.

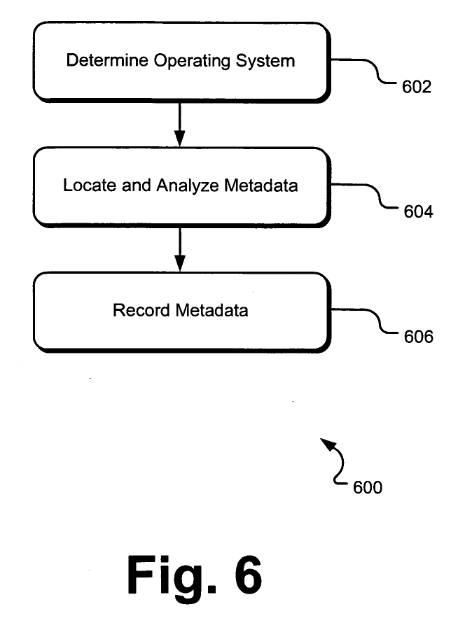

FIG. 6 illustrates an exemplary implementation of the identify data operation 408 discussed with reference to FIG. 4 above. In the illustrated identify data implementation 600, three operations are identified. In alternate implementations, the number of operations could be reduced or expanded. The determine operating system operation 602 examines the initial computer system in order to determine the type of operating system employed. Different operating systems often store and structure metadata describing file structures and locations differently.

The locate and analyze metadata operation 604 compares the operating system information ascertained in the determine operating system operation 602 to a repository of known operating systems and their associated metadata characteristics. In one implementation, the locate and analyze metadata operation 604 utilizes a lookup table to find metadata characteristics associated with a particular operating system. In an alternate implementation, the locate and analyze metadata operation 604 accesses a network to retrieve appropriate metadata information. The locate and analyze metadata operation 604 also examines the metadata to determine data types (i.e., user data, executable data, and settings data) and locations.

The record metadata operation 606 writes metadata information to a storage location. The storage location may be on the transportable storage medium or on the initial computer system. In one implementation, the metadata is recorded in tabular format. A suitable table could include columns for data type, data name, original data location, and new data location. The new data location column is completed during the modify data location operations 700. In another implementation, a metadata index is created so that the information contained in the metadata can be rapidly accessed when needed.

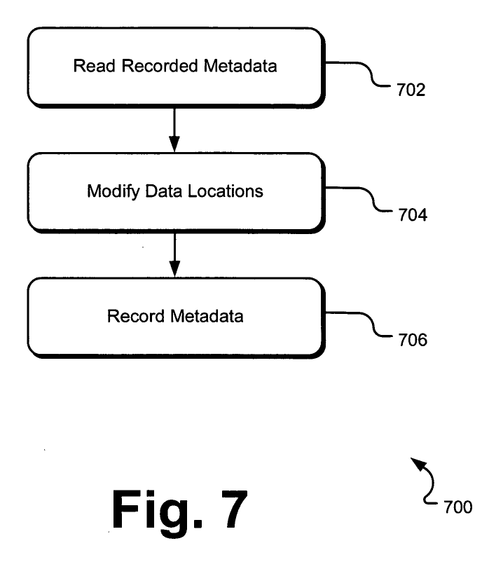

FIG. 7 illustrates an exemplary implementation of the modify data pointers operation 410 discussed with reference to FIG. 4 above. In the illustrated modify data pointers implementation 700, three operations are identified. In alternate implementations, the number of operations could be reduced or expanded. The read recorded metadata operation 702 examines the metadata recorded during the identify data operations 600. As noted above, the recorded metadata can be newly created metadata or an index to the original metadata. The modify data locations operation 704 reads the original data pointers for the user data and modifies them to point to locations on the transportable storage medium to which the user data will be relocated. For example, the My Documents folder is of the “user data” type and the original location of the folder in the data pointer is “c:\documents and settings\user\my documents\.” The modify data locations operation 704 modifies the data pointer to reference the new location on the transportable storage medium: “\transportable storage medium\documents and settings\user\my documents\.”

The record metadata operation 706 writes the modified metadata to the transportable storage medium. The operation writes both the updated data pointers as well as any associated metadata. Once the record metadata operation 706 is complete, an attempt to access user data will be directed by a modified data pointer to the transportable storage medium instead of the primary storage medium on the initial computer system.

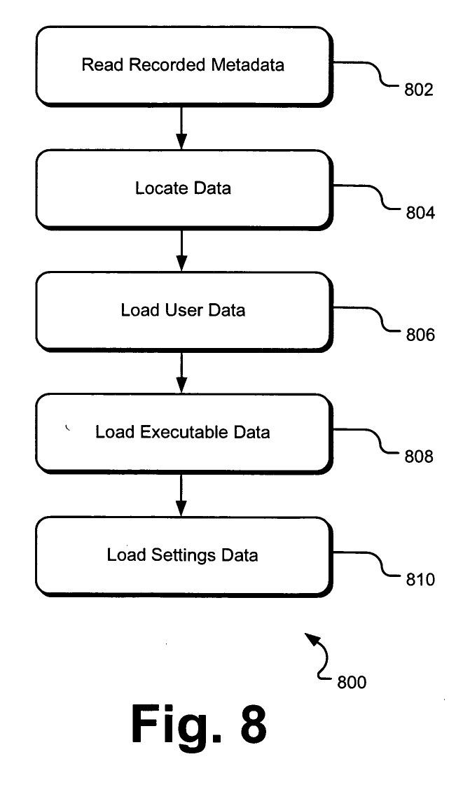

FIG. 8 illustrates an exemplary implementation of the load data processes 412, 420, and 424 discussed with reference to FIG. 4 above. In the illustrated load data processes implementation 800, five operations are identified. In alternate implementations, the number of operations could be reduced or expanded. The read recorded metadata operation 802 examines the metadata recorded during the modify data pointers operations 700 of FIG. 7. As noted above, the recorded metadata can be newly created metadata or an index to the original metadata. The locate data operation 804 uses the information retrieved during the read recorded metadata operation 802 to pinpoint the user data, executable data, and settings data on the primary storage medium of the initial computer system.

The load user data operation 806 relocates (e.g., a copy or a move operation) the user data identified in the identify data operations 600 from the original storage medium to the transportable storage medium as structured user data. Once the relocation of user data (which includes the My Documents folder) has occurred, an attempt by the user to access the My Documents folder is directed by the data pointers to the appropriate location on the transportable storage medium. The user then “works” with the user data on the transportable storage medium. Once a user is working with user data on the transportable storage medium, if the computer system's primary storage medium fails, the user data is not lost.

The load executable data operation 808 accesses metadata and uses the information contained therein to image the executable data from the original storage medium to the transportable storage medium. In an alternate implementation, the load executable data operation 808 utilizes any of a number of procedures that, though technologically similar to imaging, are distinct methods of relocating data (e.g., copy, backup, compress and copy, etc.).

The load settings data operation 810 accesses metadata and uses the information contained therein to image the settings data from the original storage medium to the transportable storage medium. In an alternate implementation, the load settings data operation 810 utilizes any of a number of procedures that, though technologically similar to imaging, are distinct methods of relocating data (e.g., copy, backup, compress and copy, etc.). In yet another implementation, the settings data is imaged to a tertiary storage medium. It is important to note that the settings data can be relocated to a single storage medium or to many storage media.

In the implementation illustrated in FIG. 8, the user data, executable data and settings data are loaded separately. In an alternate implementation, the user data, executable data and settings data are loaded concurrently. In yet another implementation, two of the three data types are loaded concurrently and the third type is loaded separately.

Each of the load operations illustrated in FIG. 8 can occur more than once, thereby providing backup copies of the data types. In another implementation, the load operations can be performed occasionally, periodically, or at a user's request in order to create a number of “snapshots” of the executable data, settings data, and user data.

FIG. 9 shows an exemplary implementation of a boot process 910 for a host computer system. In this implementation, the host computer system begins the boot process 910 by initializing a power supply in operation 912. Once the power supply has been initialized and is producing a reliable power supply for the system, a central processing unit (CPU) accesses a start of a basic input/output system (BIOS) boot program in a BIOS read-only memory (ROM) of the host computer system in operation 914. The CPU then begins executing the BIOS boot program in operation 916. The start BIOS boot program, for example, may comprise a “jump” instruction identifying system memory location at which the BIOS boot program is stored in the system memory.

The CPU performs a power-on self-test in operation 918. The power-on self-test, for example, tests a CMOS random-access memory (RAM), inventories hardware devices of the host system, such as hard drives, floppy drives, removable storage devices, ports, a keyboard, a mouse, and the like, and determines whether the host system is operating correctly.

The BIOS boot program then searches for an operating system to load onto the host computer system. In the exemplary implementation of FIG. 9, for example, the BIOS boot program accesses BIOS configuration settings stored in the CMOS RAM of the host system in operation 920 to determine an order of locations to search for a master boot record including an operating system boot code. The BIOS configuration settings may be fixed or configurable within the host system. In one implementation, for example, the BIOS configuration settings may comprise the following boot sequence:

(1) a network card;

(2) a compact disc (CD) drive;

(3) a removable media (e.g., a LS/ZIP, universal serial bus (USB), or personal computer memory card international association (PCMCIA) media);

(4) a floppy drive; and

(5) a hard drive.

The CPU accesses the first device listed in the BIOS configuration settings (e.g., a network card) to determine whether the device includes a master boot record in operation 922. In this operation, if the CPU determines that the device does not have a master boot record in operation 924, the CPU accesses the next device listed in the BIOS configuration settings (e.g., a CD drive) in operation 926. If the device does have a master boot record, however, the BIOS boot program hands off control of the CPU to the operating system boot code stored on the device and the CPU begins booting the operating system by executing the operating system boot code in operation 928.

In one implementation, for example, a transportable storage medium includes a master boot record including a jump to a micro operating system boot code. The BIOS boot program then passes control of the CPU to the micro operating boot code stored on the transportable storage medium, which loads a micro operating system from the transportable storage medium onto the host system in operation 928.

The micro operating system then loads a virtual machine onto the host computer system in operation 930, which operates on top of the micro operating system as described above. Alternatively, the virtual machine may be implemented in hardware or a combination of hardware and software on the CPU itself. The micro operating system then triggers a virtual computing environment manager in operation 932, which in turn operates on top of the virtual machine.

Then in operation 934, the virtual computing environment manager executes a virtual operating system from the transportable storage medium as described above. The virtual computing manager, for example, loads an image file from the storage medium, which operates on top of the virtual computing environment manager to make the environment transparent to a user.

The virtual computing environment manager manages executable files from the image file stored on the transportable storage medium that execute within the virtual operating system in operation 936. The virtual computing environment manager further controls access to and from user data stored on the storage medium by the user in operation 936.

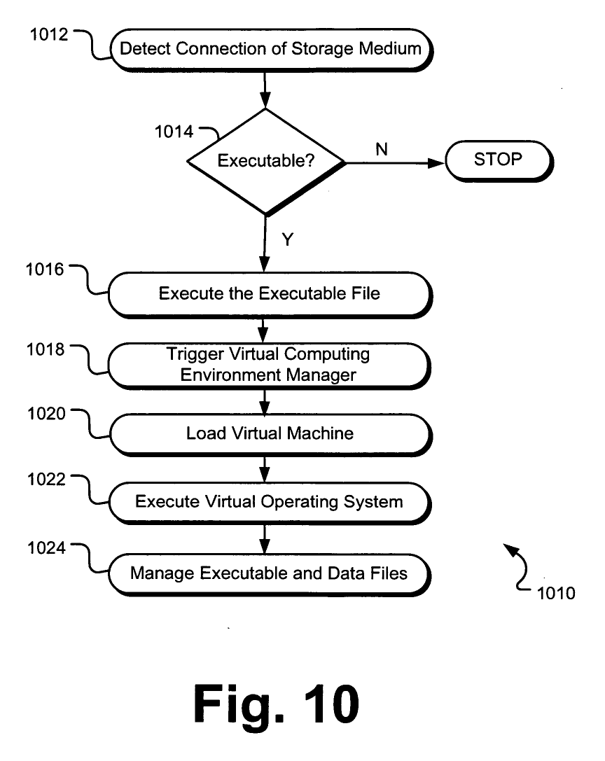

FIG. 10 shows an exemplary process 1010 in which a virtual computing environment is automatically established on the host computer system when a transportable storage medium is connected to the host computer system. In this exemplary implementation, the host system detects a connection of the transportable storage medium in operation 1012. The detection, for example, may occur via a Plug and Play or other detectable connection of the transportable storage medium to the host computer system.

The host computer system then accesses the transportable storage medium to determine if an executable file is available to establish the virtual computing environment in operation 1014. If such an executable file is not present, the host computer system stops the automatic execution. If the executable file is present, however, the host computer system continues to operation 1016, where it executes the executable file (e.g., an autorun.inf file in a Microsoft Windows® environment). The executable file triggers a virtual computing environment manager in operation 1018.

The virtual computing environment manager, in one implementation, loads a virtual machine onto the host system in operation 1020. The virtual machine operates on top of an operating system already operating on the host system and creates a virtual hardware environment. Alternatively, the virtual machine may be implemented in hardware or a combination of hardware and software on the CPU itself and the virtual computing environment manager creates the virtual hardware environment.

Then, in operation 1022, the virtual computing environment manager executes a virtual operating system from the transportable storage medium as described above. The virtual computing environment manager, for example, loads an image file from the transportable storage medium, which operates on top of the virtual computing environment manager to create a virtual computing environment transparent to a user.

The virtual computing environment manager manages executable files from the image file stored on the transportable storage medium that execute within the virtual operating system in operation 1024. The virtual computing environment manager further controls access to and from user data stored on the transportable storage medium by the user in operation 1024. Alternatively, the virtual computing environment manager may be manually executed by a user on a host computer system.

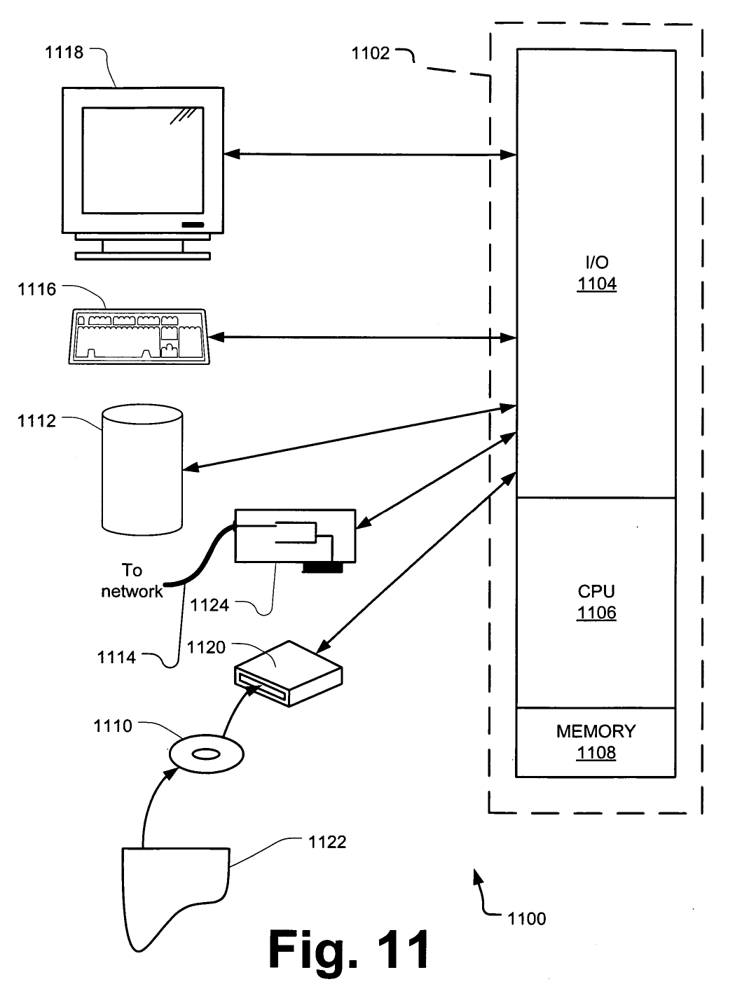

FIG. 11 illustrates an exemplary system useful in implementations of the described technology. A general purpose computer system 1100 is capable of executing a computer program product to execute a computer process. Data and program files may be input to the computer system 1100, which reads the files and executes the programs therein. Some of the elements of a general purpose computer system 1100 are shown in FIG. 11 wherein a processor 1102 is shown having an input/output (I/O) section 1104, a central processing unit (CPU) 1106, and a memory section 1108. There may be one or more processors 1102, such that the processor 1102 of the computer system 1100 comprises a single CPU 1106, or a plurality of processing units, commonly referred to as a parallel processing environment. The computer system 1100 may be a conventional computer, a distributed computer, or any other type of computer. The described technology is optionally implemented in software devices loaded in memory 1108, stored on a configured DVD/CD-ROM 1110 or a storage unit 1112, and/or communicated via a wired or wireless network link 1114 on a carrier signal, thereby transforming the computer system 1100 in FIG. 11 into a special purpose machine for implementing the described operations.

The I/O section 1104 is connected to one or more user interface devices (e.g., a keyboard 1116 and a display unit 1118), a disk storage unit 1112, and a disk drive unit 1120. Generally, in contemporary systems, the disk drive unit 1120 is a DVD/CD-ROM drive unit capable of reading DVD/CD-ROM media 1110, which typically contains programs and data 1122. Computer program products containing mechanisms to effectuate the systems and methods in accordance with the described technology may reside in the memory section 1108, on a disk storage unit 1112, or on the DVD/CD-ROM media 1110 of such a system 1100. Alternatively, a disk drive unit 1120 may be replaced or supplemented by a floppy drive unit, a tape drive unit, or other storage medium drive unit.

A network adapter 1124 is capable of connecting the computer system to a network via a network link 1114, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a local area network (LAN) environment, the computer system 1100 is connected (by wired connection or wirelessly) to the LAN through the network interface or adapter 1124, which is one type of communications device. When used in a wide area network (WAN) environment, the computer system 1100 typically includes a modem, a network adapter, or any other type of communications device for establishing communications over the wide area network. In a networked environment, program modules depicted relative to the computer system 1100 or portions thereof, may be stored in a remote memory storage device. It is appreciated that the network connections shown are exemplary and other means of and communications devices for establishing a communications link between the computers may be used.

In accordance with an implementation, software instructions and data directed toward creating and maintaining a computing environment assurance tool and associated operations may reside on the disk storage unit 1112, disk drive unit 1120 or other storage medium units coupled to the system. Such software instructions may also be executed by CPU 1206.

The embodiments of the invention described herein may be implemented as logical steps in one or more computer systems. The logical operations of the present invention may also be implemented as a sequence of processor-implemented steps executing in one or more computer systems or as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

Additionally, connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

The above specification, examples and data provide a complete description of the structure and use of exemplary embodiments of the invention. It is intended that all matter contained in the above description or shown in the accompanying drawings shall be interpreted as illustrative only and not limiting. Although various embodiments of this invention have been described above with a certain degree of particularity, or with reference to one or more individual embodiments, those skilled in the art could make numerous alterations to the disclosed embodiments without departing from the spirit or scope of this invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method of instantiating a transportable computing environment on a host computing system, comprising:
reading a virtual computing environment manager from a transportable storage medium;
executing the virtual computing environment manager on the host computing system;
reading, through the virtual computing environment manager, the transportable computing environment from the transportable storage medium; and
triggering, through the virtual computing environment manager, execution of the transportable computing environment within a virtual machine on the host computing system.

2. A computer-readable medium having computer-executable instructions for performing a computer process that implements the operations recited in claim 1.

3. The method of claim 1, wherein reading the transportable computing environment from the transportable storage medium further comprises reading at least one operating system executable from the transportable storage medium.

4. The method of claim 1, wherein reading the transportable computing environment from the transportable storage medium further comprises reading at least one user setting from the transportable storage medium.

5. The method of claim 1, wherein executing the virtual computing environment manager on the host computing system further comprises executing the virtual computing environment manager to configure the virtual machine on the host computing system to execute the transportable computing environment.

6. The method of claim 1 further comprising:
reading the virtual machine from the transportable storage medium; and
triggering, through the virtual computing environment manager, execution of the virtual machine on the host computing system.

7. A computer-readable medium having computer-executable instructions for performing a computer process that implements the operations recited in claim 6.

8. The method of claim 1, wherein reading the transportable computing environment comprises reading at least one of: executable data, settings data, or user data.

9. The method of claim 1, wherein executing the virtual computing environment manager on the host computing system further comprises providing intelligent feedback on hardware settings within the host computing system to configure the virtual machine without an external user's input.

10. A method of instantiating a virtual computing environment on a host computer system, the method comprising
loading a virtual computing environment manager from a transportable storage medium onto the host computer system;
instantiating a virtual machine platform on the host computer system at the direction of the virtual computing environment manager;
loading at least one computing environment component from the transportable storage medium onto the virtual machine platform at the direction of the virtual computing environment manager; and
executing the at least one computing environment component within the virtual machine platform at the direction of the virtual computing environment manager to create the virtual computing environment.

11. The method of claim 10, wherein the at least one computing environment component comprises executable data.

12. The method of claim 10, wherein the at least one computing environment component comprises executable data.

13. The method of claim 10, wherein the at least one computing environment component comprises executable data.

14. The method of claim 10 further comprising connecting the transportable storage medium to the host computer system.

15. The method of claim 10 further comprising
reading an operating system executable from the transportable storage medium; and
instantiating an operating system from the operating system executable on the host computer system.

16. The method of claim 10 further comprising
reading a virtual machine code executable from the transportable storage medium at the direction of the virtual computing environment manager; and
instantiating a virtual machine from the virtual machine code executable on the host computer system.

17. A computer-readable medium having computer-executable instructions for performing a computer process that implements the operations recited in claim 10.

18. A transportable storage device, comprising:
a communications interface adapted to communicate with a host computing system; and
a computer-readable storage medium storing computer-executable instructions for performing a computer process implementing:
a management reading module that reads a virtual computing environment manager from the transportable storage device;
a management execution module that executes the virtual computing environment manager on the host computing system;
a environment reading module that reads, through the virtual computing environment manager, a transportable computing environment from the transportable storage device; and
an environment execution module that triggers execution, through the virtual computing environment manager, of the transportable computing environment within a virtual machine on the host computing system.
